(19) United States
(12) Patent Application Publication
(10) Pub. No.: US 2026/0010937 A1
(43) Pub. Date: Jan. 8, 2026

(54) ELECTRONIC COMMERCE-ENABLED LOCAL FLEET CONNECTIVITY SYSTEM AND METHOD

(71) Applicant: Oshkosh Corporation, Oshkosh, WI (US)

(72) Inventors: Korry D. Kobel, Oshkosh, WI (US); Fredric L. Yutzy, Oshkosh, WI (US); Dan Adamson, Oshkosh, WI (US)

(73) Assignee: Oshkosh Corporation, Oshkosh, WI (US)

(21) Appl. No.: 19/324,094

(22) Filed: Sep. 9, 2025

Related U.S. Application Data
(63) Continuation of application No. PCT/US2024/019220, filed on Mar. 8, 2024.
(60) Provisional application No. 63/489,562, filed on Mar. 10, 2023.
(60) Provisional application No. 63/451,390, filed on Mar. 10, 2023.
(60) Provisional application No. 63/451,342, filed on Mar. 10, 2023.
(60) Provisional application No. 63/489,533, filed on Mar. 10, 2023.
(60) Provisional application No. 63/451,351, filed on Mar. 10, 2023.
(60) Provisional application No. 63/451,504, filed on Mar. 10, 2023.
(60) Provisional application No. 63/489,560, filed on Mar. 10, 2023.
(60) Provisional application No. 63/489,531, filed on Mar. 10, 2023.
(60) Provisional application No. 63/489,538, filed on Mar. 10, 2023.
(60) Provisional application No. 63/489,558, filed on Mar. 10, 2023.
(60) Provisional application No. 63/451,387, filed on Mar. 10, 2023.
(60) Provisional application No. 63/451,506, filed on Mar. 10, 2023.

(51) Int. Cl. G06Q 30/0601; G06Q 30/04; G07C 5/06

(52) U.S. Cl. CPC G06Q 30/06313; G06Q 30/04; G06Q 30/0639; G06Q 30/0643; G07C 5/06

(57) ABSTRACT

An electronic commerce system includes a work machine and a controller communicably coupled to the work machine and the user device. The controller is configured to generate a graphical user interface on a display, the graphical user interface comprising information related to the work machine and collect operation data from at least one of the work machine or the user device. The controller is further configured to generate a recommendation based on the operation data, provide the recommendation to a user via the graphical user interface, receive a user input interacting with the recommendation, and initiate a transaction implementing the recommendation.

### CROSS-REFERENCE TO RELATED PATENT APPLICATIONS

This application is a continuation of International Application No. PCT/US2024/019220, filed Mar. 8, 2024, which claims the benefit of and priority to (i) U.S. Provisional Application No. 63/451,342, filed on Mar. 10, 2023, (ii) U.S. Provisional Application No. 63/451,351, filed on Mar. 10, 2023, (iii) U.S. Provisional Application No. 63/451,387, filed on Mar. 10, 2023, (iv) U.S. Provisional Application No. 63/451,390, filed on Mar. 10, 2023, (v) U.S. Provisional Application No. 63/489,533, filed on Mar. 10, 2023, (vi) U.S. Provisional Application No. 63/451,504, filed on Mar. 10, 2023, (vii) U.S. Provisional Application No. 63/489,562, filed on Mar. 10, 2023, (viii) U.S. Provisional Application No. 63/451,506, filed on Mar. 10, 2023, (ix) U.S. Provisional Application No. 63/489,531, filed on Mar. 10, 2023, (x) U.S. Provisional Application No. 63/489,538, filed on Mar. 10, 2023, (xi) U.S. Provisional Application No. 63/489,558, filed on Mar. 10, 2023, and (xii) U.S. Provisional Application No. 63/489,560, filed on Mar. 10, 2023, each of which are incorporated herein by reference in their entireties.

### BACKGROUND

Work equipment such as lifts and telehandlers sometimes require tracking, tasking, monitoring, and servicing at a worksite. Operators and service technicians often receive information regarding products and services related to the work equipment from inefficient systems and methods to.

### SUMMARY

One exemplary embodiment relates to an electronic commerce system including a work machine communicably coupled to a controller communicably coupled to the work machine and a user device. The controller is configured to generate a graphical user interface on a display, the graphical user interface comprising information related to the work machine and collect operation data from at least one of the work machines or the user device. The controller is further configured to receive advertisement data based on the operation data, provide the advertisement data to a user via the graphical user interface, receive a user input interacting with the advertisement data, and initiate a transaction related to the advertisement data.

Another exemplary embodiment relates to a method of providing advertising related to one or more work-machines. The method includes providing a first work machine and providing a user device connected to the first work machine via a wireless network. The method further includes generating, with a controller, a graphical user interface on a display, the graphical user interface comprising information related to the first work machine, collecting operation data from at least one of the first work machine or the user device, receiving advertisement data for the user based on the operation data, providing the advertisement data to the user via the graphical user interface, receiving a user input interacting with the advertisement data, and initiating a transaction related to the advertisement data.

Another exemplary embodiment relates to a work machine including a chassis, an implement coupled to the chassis, a prime mover configured to power the implement, a sensor coupled to the chassis and position to monitor the operation of the work machine, and a non-transitory computer-readable storage medium. The non-transitory computer-readable storage medium has instructions stored thereon that, upon execution by a processor of a controller cause the processor to generate a graphical user interface on a display, the graphical user interface comprising information related to the work machine, collect operation data from at least one of the work machine or a user device communicably coupled to the work machine, generate a recommendation based on the operation data, provide the recommendation to a user via the graphical user interface, receive a user input interacting with the recommendation, and initiate a transaction implementing the recommendation.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a schematic representation of a work machine including a work machine control module, according to an exemplary embodiment;

FIG. 2 is a schematic representation of a local fleet connectivity system, according to an exemplary embodiment;

FIG. 3 is a schematic representation of a local fleet connectivity system of FIG. 2 with an M2X module to facility connectivity, according to an exemplary embodiment;

FIG. 4 is a schematic representation of a worksite and work machine staging area with a local fleet connectivity system deployed, according to an exemplary embodiment;

FIG. 5 is an illustration of two lift devices at a worksite connected by the local fleet connectivity system of FIG. 2, according to an exemplary embodiment;

FIG. 6 is an illustration of a lift device providing connectivity to a remote user via the local fleet connectivity system of FIG. 2, according to an exemplary embodiment;

FIG. 7 is a schematic representation of a worksite with a local fleet connectivity system of FIG. 2 providing connectivity to off-site systems, according to an exemplary embodiment;

FIG. 8 is an illustration of a lift device configured with the local fleet connectivity system of FIG. 2, according to an exemplary embodiment;

FIG. 9 is a graphical user interface of the local fleet connectivity system of FIG. 2, according to an exemplary embodiment;

FIG. 10 is an illustration of a work machine with machine specific output data connected to the local fleet connectivity system of FIG. 2, according to an exemplary embodiment;

FIG. 11 is illustrations of work machines configured for use in the local fleet connectivity system of FIG. 2, according to an exemplary embodiment;

FIG. 12 is a flow diagram of a method for an electronic commerce-enabled local fleet connectivity system, according to an exemplary embodiment;

FIG. 13 is a flow diagram of a method for an electronic commerce-enabled local fleet connectivity system to recommend replacement components, according to an exemplary embodiment.

FIG. 14 is a flow diagram of a method for an electronic commerce-enabled local fleet connectivity system to recommend replacement components, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

According to an exemplary embodiment, a work machine is connected to an electronic commerce (“ecommerce”)—enabled local fleet connectivity system to provide operators and service technicians information regarding work equipment via an efficient worksite system. The ecommerce-enabled local fleet connectivity system provides means to quickly and effectively connect work machines with wireless digital services, for example with devices and applications, to assist a user in identifying a particular machine and the state of the machine thereby saving time, improving efficiency, and reducing costs. According to an exemplary embodiment, the ecommerce-enabled local fleet connectivity system may provide additional wireless digital services to a connected work machine to support commercial functions thereby increasing revenues associated with work equipment. For example, the ecommerce-enabled local fleet connectivity system supports commercial services including advertising, user preference identification, point of sale, third-party messaging, etc. In some embodiments, the digital services provided by the ecommerce-enabled local fleet connectivity system may also be provided by an ecommerce application hosted by and/or run on a work machine or a user device. The ecommerce application may execute and perform some or all of the same processes described herein as they relate to the ecommerce-enabled local fleet connectivity system.

Advertising and other ecommerce functions supported by the ecommerce-enabled local fleet connectivity system may, for example, be based on the specific machine or machines being accessed, a profile or nature of a user accessing the specific machine or machines, the weather or local conditions at a worksite or around the machine or machines, the conditions associated with the machine (e.g., engine hours, fault codes, etc.), the location of the machine, etc. For example, the ecommerce application may monitor the operations of a work machine and/or a worksite and deliver advertisements based on the operations. In some embodiments, the ecommerce-enabled local fleet connectivity system supports a channel or an application to advertise products (e.g., service kits from a work equipment manufacturer) directly to a work machine user with a tab or page of the ecommerce application, a click-through popup within the ecommerce application, a scrolling banner within the application, push notifications etc. In some embodiments, the application may generate one or more of audio, visual, and tactile signals to convey messages associated with commercial services. According to an exemplary embodiment, the ecommerce application is run on a remote user device in communication with the work machine, such that the tailored advertisements are delivered in app on the remote user device. In some embodiments, the ecommerce-enabled local fleet connectivity system application may provide a portal for purchasing products advertised through the system. According to an exemplary embodiment, the ecommerce application is implemented on machines and/or devices within a local fleet connectivity system to make up a ecommerce-enabled local fleet connectivity system. The ecommerce-enabled local fleet connectivity system may be a worksite-based wireless network established by work machines, nodes, connectivity modules, etc. at the worksite.

Referring to the figures generally, various exemplary embodiments disclosed herein relate to systems and methods for an ecommerce-enabled local fleet connectivity system and applications. For example, an ecommerce-enabled local fleet connectivity system includes work machines connected via a local fleet connectivity system and running an ecommerce application.

According to an exemplary embodiment, an ecommerce application is hosted on one or more of a work machine controller and/or a user device which may generate user interfaces for providing the commercial services. In some embodiments, the application may generate one or more of audio, visual, and tactile signals to convey messages associated with commercial services. In some embodiments, the application may be configured to display recommended purchases to the user based on the state or condition of a machine. In some embodiments, the ecommerce application is connected to a local fleet connectivity system to create an ecommerce-enabled local fleet connectivity system. The ecommerce application may display information from other machines connected to the work machine hosting the ecommerce application or parameter associated with a user of the electronic commerce-enabled local fleet connectivity system and/or ecommerce application. In some embodiments, the ecommerce application advertises products and services (e.g., service kits) with/within a tab or page within the application, a click-through popup within the application, a scrolling banner within the application, push notifications etc. The advertised products and services may be original equipment manufacturer (OEM) products and services, or products and services from another and/or multiple providers.

According to an exemplary embodiment, the ecommerce application may determine the advertising provided based on information including the specific machine(s) being accessed, the profile or nature of the person accessing the machine(s), the weather or local conditions around the machine(s), conditions associated with the machine(s) (e.g., engine hours, fault codes, etc.), the location of the machine(s), etc. In some embodiments, the application may provide a portal for point of sale services (e.g. order entry, payment acceptance, order tracking, etc.). The portal may include a user interface.

According to an exemplary embodiment, the ecommerce application may be run in an ecommerce-enabled local fleet connectivity system. which may include a local fleet connectivity system which wirelessly connects one or more machines at a site to provide improved connectivity and productivity. Network connections between work machines and other nodes connected to the local fleet connectivity system may include low energy wireless data networks, mesh networks, short-range wireless networks, satellite communications networks, cellular networks, or other wireless data networks. In some embodiments, a first work machine extends a connection to a second work machine in proximity to the first work machine on a worksite to establish a network link at the worksite. The resulting local fleet connectivity system is a network established among a fleet of work machines at the worksite with the work machines connecting with others nearby to form a mesh network. For example, Bluetooth Low Energy (BLE) Machine to Machine (M2M) communication protocols may be used to expand communication at a worksite via local connectivity between machines at the worksite. In some embodiments, the ecommerce-enabled local fleet connectivity system may automatically identify the equipment connected to the network. The ecommerce-enabled local fleet connectivity system may also group and categorize the equipment, for example based on manufacturer, location, type, etc.

In some embodiments, an ecommerce-enabled local fleet connectivity system may include various work machines of one or more types, interface modules, worksite equipment, communications devices, communications networks, user interface devices, devices hosting ecommerce-enabled local fleet connectivity software, and user interfaces. The ecommerce-enabled local fleet connectivity system users may include equipment users, equipment maintainers, equipment suppliers, worksite/worksite supervisors, remote users, etc. In some embodiments, the information provided to the ecommerce-enabled local fleet connectivity system may be communicated to users via a user interface. In some embodiments, the user interface may include a real-time map showing a current work machine location, the location of work machines in a local fleet connectivity system, the location of an operator of a remote device connected to a local fleet connectivity system, etc. In some embodiments, the user interface includes a color-coded warning indicator, an audible alarm, or another indicator structured to communicate to the machine operator that the work machine is in a location or state that requires the attention of the operator.

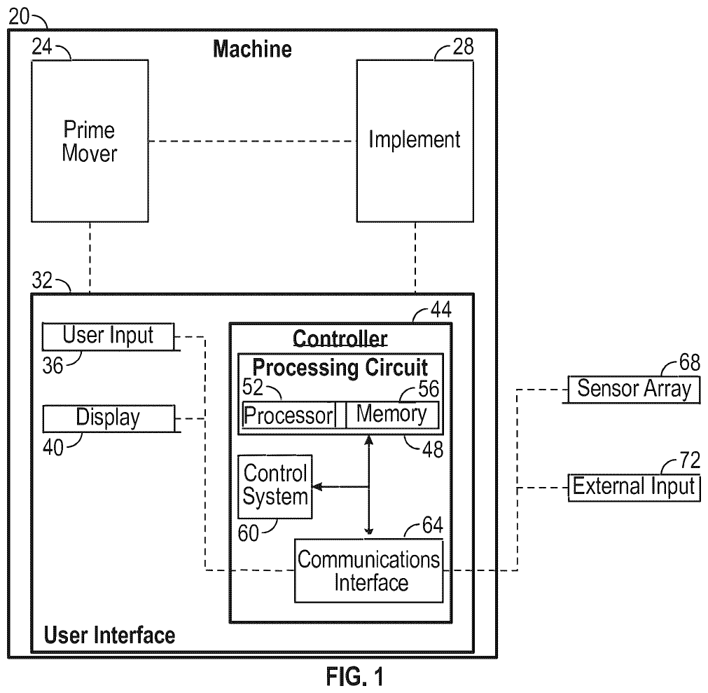

According to the exemplary embodiment shown in FIG. 1, a work machine such as lift device (e.g., aerial work platform, telehandler, boom lift, scissor lift, etc.), shown as work machine 20, includes a prime mover (e.g., a spark ignition engine, a compression ignition engine, an electric motor, a generator set, a hybrid system, etc.), shown as prime mover 24. In other embodiments, the work machine 20 is another type of vehicle (i.e., fire apparatuses, military vehicles, boom trucks, refuse vehicles, fork lifts, etc.). According to an exemplary embodiment, the prime mover 24 is structured to supply power to the work machine 20 and an implement (e.g., aerial work platform, a lift boom, a scissor lift, a telehandler arm, etc.), shown as implement 28. By way of example, the implement 28 may be a boom including one or more boom sections and a platform assembly at the end of the boom.

As shown in FIG. 1, the work machine 20 includes a user interface, shown as user interface 32, in communication with the prime mover 24 and the implement 28. The user interface 32 is configured to control the prime mover 24 and the implement 28 and therefore control the operations of the work machine 20. According to an exemplary embodiment, the user interface 32 includes a controller for operating the work machine 20, shown as controller 44. In some embodiments, the work machine is a remote-operated work machine and the user interface 32 is located on a remote device connected to the work machine. For example, the remote device can connect to the work machine via a local wireless network established by the work machine. In another embodiment, the user interface connects to the work machine via a connectivity module. According to an exemplary embodiment, one or more components of the user interface 32 are located within implement 28. For example, implement 28 may be a boom including a platform assembly for lifting workers to a desired height, and the platform assembly may contain the user input 36 and display 40 to allow an operator of the implement 28 to control the work machine 20 while onboard the platform assembly.

In some embodiments, the controller 44 is configured to monitor and control the operation of the work machine 20. According to an exemplary embodiment, the controller 44 is further configured to connect to a remote wireless network such as a cellular network.

As the components of FIG. 1 are shown to be embodied in the work machine 20, the controller 44 may be structured as one or more of a general-purpose processor, an application specific integrated circuit (ASIC), one or more field programmable gate arrays (FPGAs), a digital-signal-processor (DSP), circuits containing one or more processing components, or other suitable electronic processing components. For example, the controller 44 may be structured as one or more electronic control units (ECU) embodied within the work machine 20. The controller 44 may be separate from or included with at least one of an implement control unit, an exhaust after-treatment control unit, a powertrain control module, an engine control module, etc.

According to the exemplary embodiment shown in FIG. 1, the controller 44 includes a processing circuit 48 having a processor 52 and a memory device 56, a control system 60, and a communications interface 64. Generally, the controller 44 is structured to receive inputs and generate outputs for or from a sensor array 68 and external inputs or outputs 72 (e.g. a load map, a machine-to-machine communication, a fleet management system, a user interface, a network, etc.) via the communications interface 64.

In some embodiments, the processing circuit 48 may be structured or configured to execute or implement the instructions, commands, and/or control processes described above with respect to control system 60. The control system 60 may be embodied as non-transient machine or computer-readable media that is executable by a processor, such as processor 52. As described herein, and amongst other uses, the machine-readable media facilitates the performance of certain operations to enable reception, storage, and transmission of data. For example, the machine-readable media may provide an instruction (e.g., command, etc.) to acquire data such as service, operator, and parts manuals associated with the work machine 20. In this regard, the machine-readable media may include programmable logic that defines the frequency of acquisition of the data (or, transmission of the data). According to an exemplary embodiment, the computer readable media includes code, which may be written in any programming language including, but not limited to, Java or the like and any conventional procedural programming languages, such as the “C” programming language or similar programming languages. In some embodiments, the computer readable program code may be executed on one processor or multiple remote processors. In the latter scenario, the remote processors may be connected to each other through any type of network (e.g., CAN bus, etc.).

According to another exemplary embodiment, the control system 60 is embodied as one or more hardware units such as those described above with reference to the controller 44 itself. The control system 60 may be embodied as one or more circuitry components including, but not limited to, processing circuitry, network interfaces, peripheral devices, input devices, output devices, sensors, etc. In some embodiments, the control system 60 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the control system 60 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The control system 60 may also include programmable hardware devices such as FPGAs, programmable array logic, programmable logic devices or the like. According to an exemplary embodiment, the control system 60 may include one or more memory devices for storing instructions that are executable by one or more of the processor(s) of the control system 60 and/or processor 52. The one or more memory devices and processor(s) may have the same definition as provided below with respect to the memory device 56 and processor 52. In some hardware unit configurations, the control system 60 may be physically dispersed throughout separate locations in the machine. Alternatively, and as shown, the control system 60 may be embodied in or within a single unit/housing, which is shown as the controller 44.

In some embodiments, the control system 60 generates a range of inputs, outputs, and user interfaces. The inputs, outputs, and user interfaces may be related to a worksite, a status of a piece of equipment, environmental conditions, equipment telematics, an equipment location, task instructions, sensor data, equipment consumables data (e.g. a fuel level, a condition of a battery), status, location, or sensor data from another connected piece of equipment, communications link availability and status, hazard information, positions of objects relative to a piece of equipment, device configuration data, part tracking data, text and graphic messages, weather alerts, equipment operation, maintenance, and service data, equipment beacon commands, tracking data, performance data, cost data, operating and idle time data, remote operation commands, reprogramming and reconfiguration data and commands, self-test commands and data, software as a service data and commands, advertising information, access control commands and data, onboard literature, machine software revision data, fleet management commands and data, logistics data, equipment inspection data including inspection of another piece of equipment using onboard sensors, prioritization of communication link use, predictive maintenance data, tagged consumable data, remote fault detection data, machine synchronization commands and data including cooperative operation of machines, equipment data bus information, operator notification data, work machine twinning displays, commands, and data, etc.

As shown in FIG. 1, the controller 44 also includes the processing circuit 48 having the processor 52 and the memory device 56. The processing circuit 48 may be structured or configured to execute or implement the instructions, commands, and/or control processes described above with respect to control system 60. The depicted configuration represents the control system 60 as machine or computer-readable media. However, as mentioned above, this illustration is not meant to be limiting as the present disclosure contemplates other embodiments where the control system 60, or at least one circuit of the control system 60, is configured as a hardware unit and/or is embodied within the processing circuit 48. All such combinations and variations are intended to fall within the scope of the present disclosure.

According to an exemplary embodiment, hardware and data processing components that make up the processing circuit 48 and which are used to implement the various processes, operations, illustrative logics, logical blocks, modules and circuits described in connection with the embodiments disclosed herein (e.g., the processor 52) may be implemented or performed with a general purpose single-or multi-chip processor, a DSP, an ASIC, an FPGA, or other programmable logic device, discrete gate or transistor logic, discrete hardware components, or any combination thereof designed to perform the functions described herein. A general purpose processor may be a microprocessor, or, any conventional processor, or state machine. According to an exemplary embodiment, the processor 52 may also be implemented as a combination of computing devices, such as a combination of a DSP and a microprocessor, a plurality of microprocessors, one or more microprocessors in conjunction with a DSP core, or any other such configuration. In some embodiments, the one or more processors that make up the processor 52 may be shared by multiple circuits (e.g., control system 60 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other embodiments, two or more processors may be coupled via a bus to enable independent, parallel, pipelined, or multi-threaded instruction execution. All such variations are intended to fall within the scope of the present disclosure.

The memory device 56 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory 56 may be any tangible, non-transient, volatile or non-volatile computer-readable storage medium capable of storing data or computer code relating to the activities described herein. For example, the memory device 56 may include database components, object code components, script components, or any other type of information structure for supporting the various activities and information structures described herein. According to the exemplary embodiment shown in FIG. 1, the memory device 56 is communicably connected to the processor 52 via the processing circuit 48 to provide the computer code or instructions to the processor 52 for executing at least some of the processes described herein.

According to an exemplary embodiment, the memory device 56 stores instructions for execution by the processor 52 for a process to automatically generate a worksite equipment grouping. The process to automatically generate a worksite equipment grouping automatically associates machines 20 connected on a near network to one or more other machines 20. In some embodiments, the automatic associations are based on rule stored on a work machine or on another network node. In some embodiments, the association rules are based on one or more of a worksite designation, a location of a machine, or a code (e.g. a customer key, a manufacturer key, or a maintainer key).

As shown in FIG. 1, the work machine 20 includes an integrated display (e.g., a display screen, a lamp or light, an audio device, a dial, or another display or output device), shown as display 40. The display 40 may be configured to display a graphical user interface, an image, an icon, and/or other information. According to an exemplary embodiment, the display includes a graphical user interface configured to provide access digital services including advertisements and a point of sale. The graphical user interface may also be configured to display current status information and other details of an ecommerce-enabled local fleet connectivity system.

As shown in FIG. 1, the user interface 32 includes a user input, shown as user input 36. The user input 36 may include one or more buttons, knobs, touchscreens, switches, levers, joysticks, pedals, steering wheels, handles, etc. The user input 36 may facilitate manual control over some or all aspects of the operation of the work machine 20. It should be understood that any type of display or input controls may be implemented with the systems and methods described herein.

As shown in FIG. 1, the controller 44 includes a communications interface 64 configured to receive inputs and generate outputs for or from the sensor array 68 and the external inputs or outputs 72 (e.g. a load map, a machine-to-machine communication module, a fleet management system, a user interface, a network, etc.). The sensor array 68 can include physical and virtual sensors for determining work machine states, work machine conditions, work machine locations, loads, and location devices. In some embodiments, the sensor array includes a GPS device, a LIDAR location device, inertial navigation, or other sensors structured to determine a position of the work machine 20 relative to locations, maps, other equipment, objects or other reference points. In some embodiments, the communications interface 64 provides a connection to an ecommerce-enabled local fleet connectivity system. In other embodiments, the work machine 20 is communicably coupled to a connectivity module, and the connectivity module provides communication between the work machine 20 and the ecommerce-enabled local fleet connectivity system.

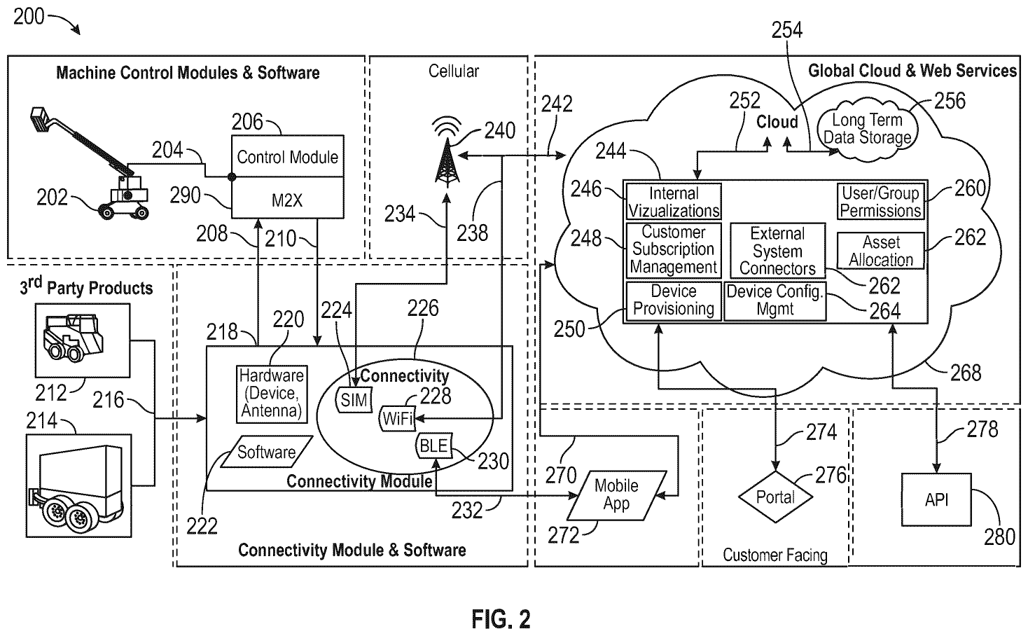

As shown in FIG. 2, the ecommerce-enabled local fleet connectivity system 200 is supported by a network of nodes. The nodes may include one or more work machines 202, each with a control module 206, one or more connectivity modules 218, and/or one or more network devices hosting, for example, user interfaces 272, network portals 276, application interfaces/application programming interfaces 280, data storage systems 256, cloud and web services, and product development tool and application hubs 244. The ecommerce-enabled local fleet connectivity system may enable communication between connected work machines and allow for commands and data to be exchanged according to one or more commands or machine states.

As shown in FIG. 2, the work machine 202 is communicably connected via connection 204 to a control module 206. According to an exemplary embodiment, the control module 206 includes the user interface 32 discussed above with reference to FIG. 1. The connection 204 between the work machine 202 and the control module 206 may be wired or wireless thus providing the flexibility to integrate the control module with the work machine 202 or to temporarily attach the control module 206 to the work machine 202. The control module 206 may be configured or may be reconfigurable in both hardware and software to interface with a variety of work machines, such as work machine 202 and third-party products 212, 214. According to an exemplary embodiment, the control module 206 is configured to interface a single work machine such as work machine 202 with one or more other work machines such as third-party products 212, 214 via the connectivity module 218. The control module 206 may comprise an integral power source or may draw power from the work machine 202 or another external source of power. A control module 206 may be installed on or connected to products (e.g. third-party products 212, 214) not configured by the original product manufacturer with a control module 206.

The work machine 202 communicably connects to the ecommerce-enabled local fleet connectivity system 200 via a machine-to-X (M2X) module 290. The M2X module 290 is communicably connected to the control module 206. In some embodiments, the M2X module 290 is an independent module. In other embodiments, the M2X module 290 and the control module 206 are embodied in the same module. According to an the exemplary embodiment shown in FIG. 2, the M2X module 290 establishes one or more communications channels 208, 210 with a connectivity module 218. The connectivity module 218 provides a plurality of links between one or more work machines 202 and third-party products 212, 214 with the ecommerce-enabled local fleet connectivity system 200. In some embodiments, the ecommerce applications run in the ecommerce-enabled local fleet connectivity system 200 may be run by the M2X modules 290 on one or more work machines 202 and/or a user interface such as user interface 272. In some embodiments, the applications may exchange commands, codes (e.g. a customer key) and data between work machines 202, third-party products 212, 214, and user devices including user interfaces 272, forming a network of interconnections among machines, devices, or nodes. In some embodiments, the self-forming network between work machines and user devices is a wireless mesh network.

As shown in FIG. 2, the connectivity module 218 includes hardware 220, itself including antennas, switching circuits, filters, amplifiers, mixers, and other signal processing devices for a plurality of wavelengths, frequencies, etc., non-volatile memory components hosting software 222, and a communications manager 226. The communications manager 226 may comprise processing circuits with communications one or more network protocol front ends, shown as front ends SIM 224, WiFi 228, and BLE 230. In some embodiments, the communications manager 226 contains one or more other front ends for example, Bluetooth, NFC, optical, VHF, UHF, and satellite communications. In some embodiments, the connectivity module 218 functions as a gateway device connecting work machine 202 to other work machines (e.g., third-party products 212, 214), application hubs 244, user interfaces 272, portals 276, APIs 280, beacons, scheduling or other fleet management and coordination systems.

According to an exemplary embodiment, the ecommerce-enabled local fleet connectivity system 200 allows for the coordination of multiple work machines 202 and third-party products 212, 214 within the same worksite and/or a fleet-wide control across multiple worksites. For example, work machine 202 and third-party products 212, 214 may coordinate to perform self-inspections at the same time and remotely report the results of a self-inspection to a user via a user device including user interface 272.

According to the exemplary embodiment shown in FIG. 2, the ecommerce-enabled local fleet connectivity system 200 provides connectivity between work machine 202, third-party products 212, 214 and remotely hosted user interface 272, network portal 276, application interfaces/application programming interface (API) 280, data storage system 256, cloud and web service 268, including product development tool and application hub 244 that function as an Internet of Things (IoT) system for operation, control, and support of work machine 202 and third-party products 212, 214. Connections 232, 234, 238, 242, 252, 254, 270, 274, and 278 between nodes connected to the ecommerce-enabled local fleet connectivity system 200 may comprise, for example, cellular networks (e.g., via cell towers 240), or other existing or new means of digital connectivity.

As shown in FIG. 2, product development tool and application hubs 244 may comprise tools and applications for internal visualizations 246, customer subscription management 248, device provisioning 250, external systems connectors 262, device configuration management 264, user/group permissions 260, asset allocation 258, fleet management, compliance, etc. In some embodiments, product development tool and application hubs 244 communicates with the user interface 272 to provide one or more digital services as explained in further detail below.

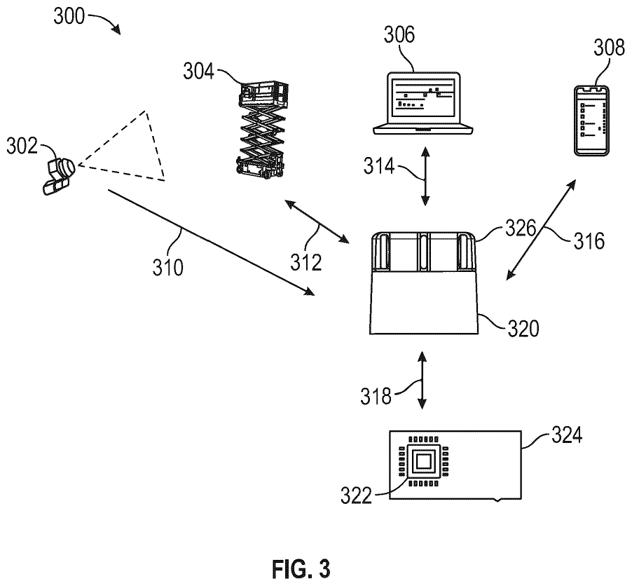

As shown in FIG. 3, the M2X module 320 facilitates communication between the control system 322 of the work machine 324 and other elements connected to the ecommerce-enabled local fleet connectivity system 300. The M2X module 320 may be part of the work machine 324 or may a separate part physically coupled to the work machine 324. The M2X module 320 may exchange commands and data 318 with the control system 322; sensor data 310 with auxiliary sensors 302; machine data 312 with another machine 304; commands and data 314 with a node or portal 306; and commands, data, and information from the onboard documentation system 316 with a user device 308 running an application within the ecommerce-enabled self-forming network system. For example, a user device 308 may include an application for connecting to and/or accessing information regarding the work machine 324. The application may include advertisements based on specific machine and/or worksite information gathered by the control system 322 or from other nodes in the ecommerce-enabled local fleet connectivity system 300 such as auxiliary sensors 302, machine 304, portal 306, and user device 308. In some embodiments, the portal 306 and/or user device 308 may also provide point of sale services for purchasing related equipment and/or services recommended based on the collected information.

In some embodiments, the ecommerce-enabled local fleet connectivity system 300 may provide digital commercial services to an owner, user, operator, etc. of the work machine 324. For example, the local fleet connectivity system may include one or more ecommerce applications hosted on one or more processors. The host processors may comprise a control system 322, an M2X module controller, and a user device controller. In some embodiments, commercial services supported by the ecommerce-enabled local fleet connectivity system 300 may comprise advertising, user preference identification, point of sale, third-party messaging, etc. In some embodiments, an application hosted on one or more of a machine controller and a user device may generate user interfaces for commercial services. In some embodiments, the application may generate one or more of audio, visual, and tactile signals to convey messages associated with commercial services. In some embodiments, the application may be configured to display recommended purchases to the user based on the state or condition of the machine connected to the electronic commerce-enabled local fleet connectivity system or a parameter associated with a user of the electronic commerce-enabled local fleet connectivity system. In some embodiments, the application may provide point of sale services (e.g., order entry, payment acceptance, order tracking, etc.).

In some embodiments, ecommerce functions are accessed through a tab or page within the application, a click-through popup within the application, a scrolling banner within the application. a push notification, etc. In some embodiments, the ecommerce functions provided through the ecommerce-enabled local fleet connectivity system 300 may be managed by an ecommerce application hosted on a controller installed in a machine 304, 324 or a user device 308. Ecommerce functions provided through the ecommerce-enabled local fleet connectivity system may comprise, for example, original equipment manufacturer advertising (e.g., service kits, equipment consumables, replacement parts based on a status or condition of a machine). In some embodiments, ecommerce messages are transmitted via the electronic commerce-enabled local fleet connectivity system. Ecommerce messages may comprise, for example, messages based on a specific machine or machines being accessed, a profile or a nature of a person accessing the specific machine or machines, weather or local conditions around the machine or machines, conditions or states associated with the machine (e.g., engine hours, fault codes, etc.), location of the machine, location of the worksite, proximity of a vendor to a worksite, etc. In some embodiments, the application is a point of sale portal for purchasing items or services identified in electronic commerce messages. For example, an original equipment manufacturer (OEM) may determine a work machine component requires replacement based on the condition of the component as detected by a sensor on the work machine and reported to the OEM via the electronic commerce-enabled local fleet connectivity system. The OEM may locate the nearest replacement part, determine a price and delivery time for the part and generate a push message to a user on a user device at a worksite identifying the need to replace the component, the price and arrival time for the replacement component, a purchase incentive for ordering the component through the application, process the order through the user device, and provide post sale services (e.g., delivery status, installation instructions, warranty support) through the application.

In some embodiments, the ecommerce functions supported through the applications may include third party advertising and point of sale. For example, the electronic commerce application may provide notifications to equipment users from a restaurant or other entity in proximity to a worksite based on one or more parameters collected by the application. Parameters collected by the application may include for example, a number of users present at a worksite, a time of day, a purchase incentive from a vendor, user preferences, etc. The application may, for example, capture a record of sales conversions in response to application ecommerce messaging as a basis for revenue calculation for a sales channel supported by the electronic commerce functions enabled by the ecommerce-enabled local fleet connectivity system 300.

The ecommerce-enabled local fleet connectivity system 300 allows for the coordination of multiple machines 304, 324 within the same worksite, or a fleet wide control. For example, if a first work machine 324 is required to accomplish a task collaboratively with a second work machine 304, a user interacting with a user device 308 may provide commands to the first work machine 324 and second work machine 304 to execute the task in collaboration.

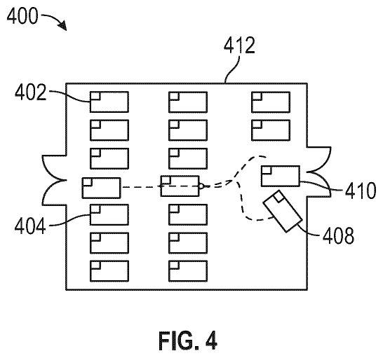

As shown in FIG. 4, the ecommerce-enabled local fleet connectivity system 400 may be deployed at a worksite 412 to control a fleet of work machines 402, 404, 408, and 410 to collaboratively perform tasks requiring more than one work machine 408, 410. For example, a user may wish to move the work machine 410 from its stored position on the left of the worksite 412 out the door on the right of the worksite. The work machines 408 and 410 may communicate with each other and coordinate their movement, causing the work machine 408 to move out of the way of the work machine 410, so that the work machine 410 can move past the work machine 408 and out the doorway.

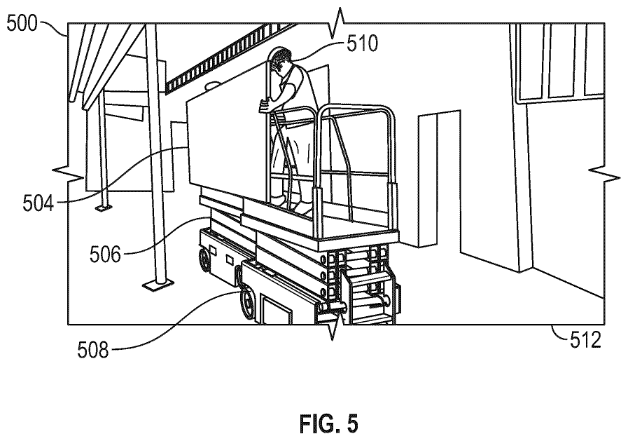

As shown in FIG. 5, a plurality of work machines 506, 508 connected to the ecommerce-enabled local fleet connectivity system 500 via integrated connectivity modules may collaboratively perform tasks on a jobsite 512 requiring more than one work machine. For example, communicating via the ecommerce-enabled local fleet connectivity system 500 the work machines 506, 508 may help place a section of drywall 504 that is too large for a single work machine. Via the ecommerce-enabled local fleet connectivity system 500 the work machine 506 and the work machine 508 and can coordinate movement so that users 510 on each work machine 506, 508 can hold the drywall 504 while the work machines 506, 508 are moving. Connectivity with the ecommerce-enabled local fleet connectivity system 500 prevents the machines 506, 508 from being separated so that the users 510 do not drop the drywall 504.

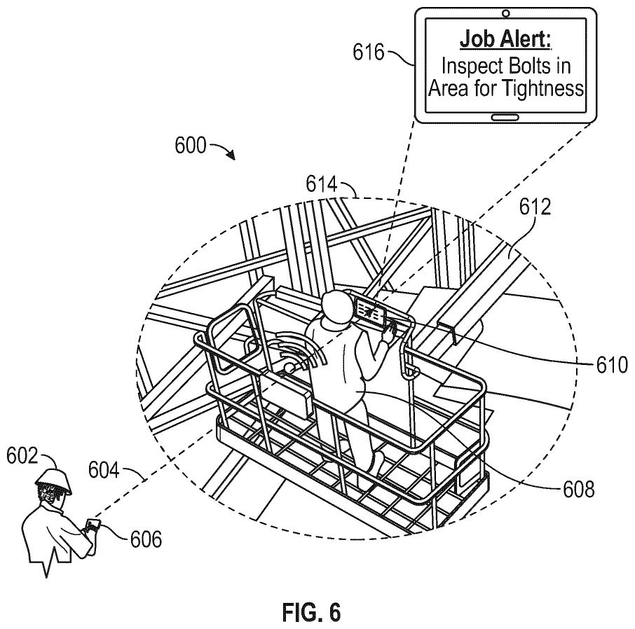

As shown in FIG. 6, a remote user 602 of a ecommerce-enabled local fleet connectivity system 600 can send messages and data 604 from a remote device 606 to an onsite user 608 on a jobsite 614. The messages and data 604 may be received by the control system 610 of a work machine 612 and displayed via a user interface on an onboard display 616. The remote user 602 may send work instructions to the onsite user 608, informing the onsite user 608 of talks to be performed using the work machine 612. For example, as shown in FIG. 6, the remote user 602 may send instructions to the onsite user 608 to use the work machine 612 to inspect bolt tightness in the area. The instructions may displayed for the onsite user 608 on the onboard display 616. This allows the onsite user 608 to receive and view the instructions without the need to call the remote user 602 or write the instructions down. Because the work machine 612 is connected to the remote device 606 (e.g., via a connectivity module 218) the remote user 602 may receive the location of the work machine 612, as well as other work machines on the jobsite 614, and may use the location information to determine the instructions to send. In some embodiments, a user such as remote user 602 is presented with advertisements associated with the work machine 612, the location of the work machine 612, its operations, etc. For example, the control system 610 may determine that the work machine 612 is consistently operating at its maximum extension level, and in response the control system 610 may provide to the remote user 602 an advertisement for another lift device with a greater lifting range. Still in other embodiments, the digital services/marketing materials may be provided to the onsite user 608.

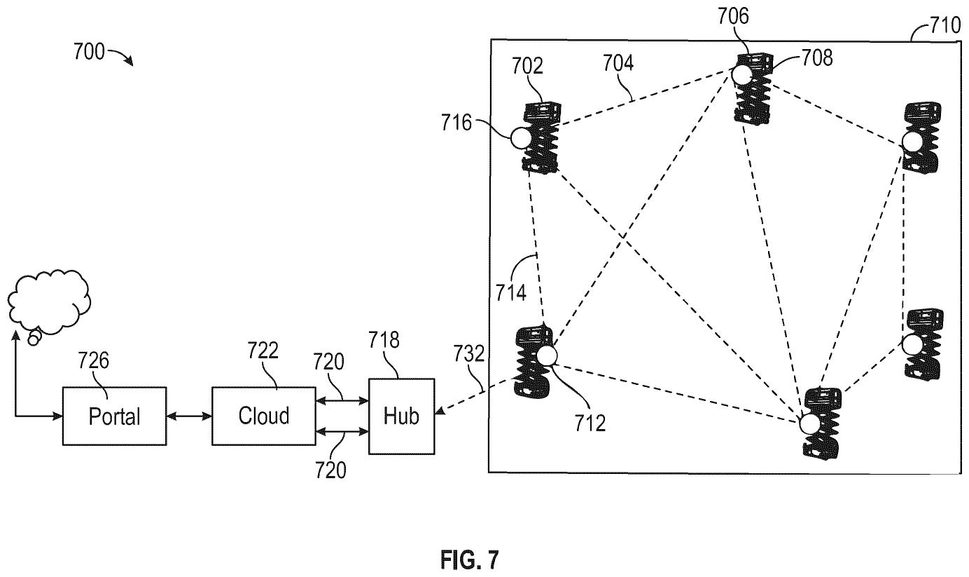

As shown in FIG. 7, a ecommerce-enabled local fleet connectivity system 700 includes a connectivity hub 718 configured to act as a central connection point for one or more work machines with their own connectivity modules. In some embodiments, the connectivity hub includes a connectivity module. In some embodiments, the connectivity hub is configured to communicatively connect with one or more connectivity module-equipped machines 702, 706 in proximity to the connectivity hub 718. In some embodiments, the connectivity hub is configured to broadcast a worksite identification signal. In some embodiments, the connectivity hub is configured to connect worksite machines 702, 706 on an ecommerce enabled local fleet connectivity network to an external internet feed 720. In some configurations, the connectivity hub is configured as a gateway to one or more communications systems or network systems to enable exchanges of data 720, 722 between nodes 708, 712, 716 on the worksite 710 local fleet connectivity mesh network 704, 714, 732 and nodes 726 external to the worksite.

In some embodiments, connectivity hub has a connectively module to (a) provides the functionalities described here in place of or in addition to a machine that has a connectivity module, (b) broadcasts a site identifier, or (c) connects to an external internet to flow through data to and from the jobsite that is provided across the mesh.

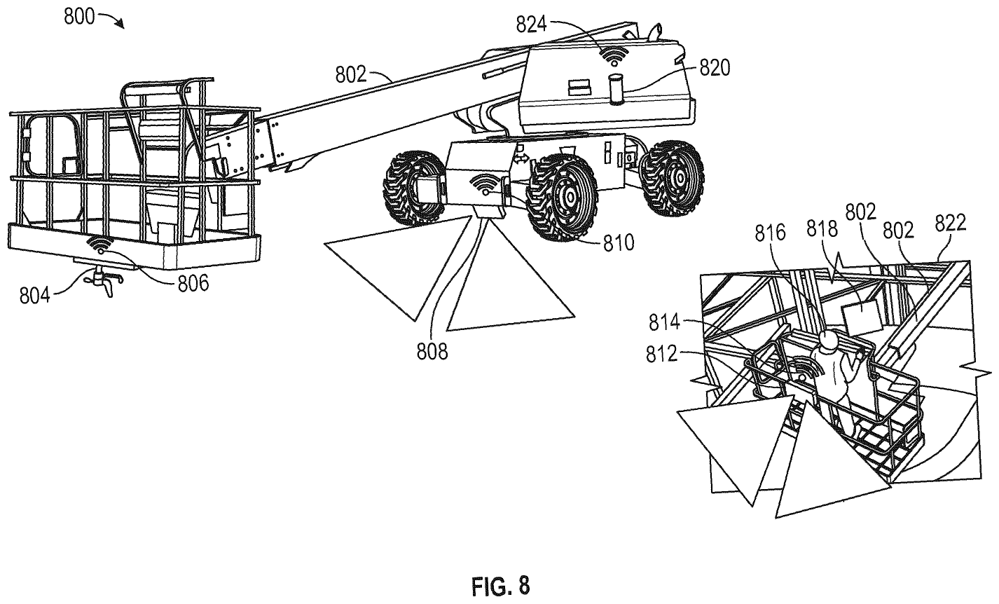

As shown in FIG. 8, work machines 802 of a ecommerce-enabled local fleet connectivity system 800 may include one or sensors. As shown in FIG. 8, sensors 804, 808, 812, 820 may be coupled to a work machine 802 on a jobsite 822. The sensors may be, for example, object detection sensors 808 812, environmental sensors 804 (e.g., wind speed, temperature sensors), and tagged consumable sensors 820. In some embodiments, one or more other sensors may also be included to measure the machine state of work machines 802, 820. The sensors 804, 808, 812, 820 may be connected to and may send data to via the ecommerce-enabled local fleet connectivity system 800 via wireless connections 806, 810, 814, 824. The sensor data may displayed or may be used to generate messages for display on an onboard display 818 for a user 816 of the work machine 802. In some embodiments, the sensor data may be used to determine a machine state or status of the work machine 802. The status may be used by an ecommerce application to provide targeted advertisements related to the work machine 802 and its operations.

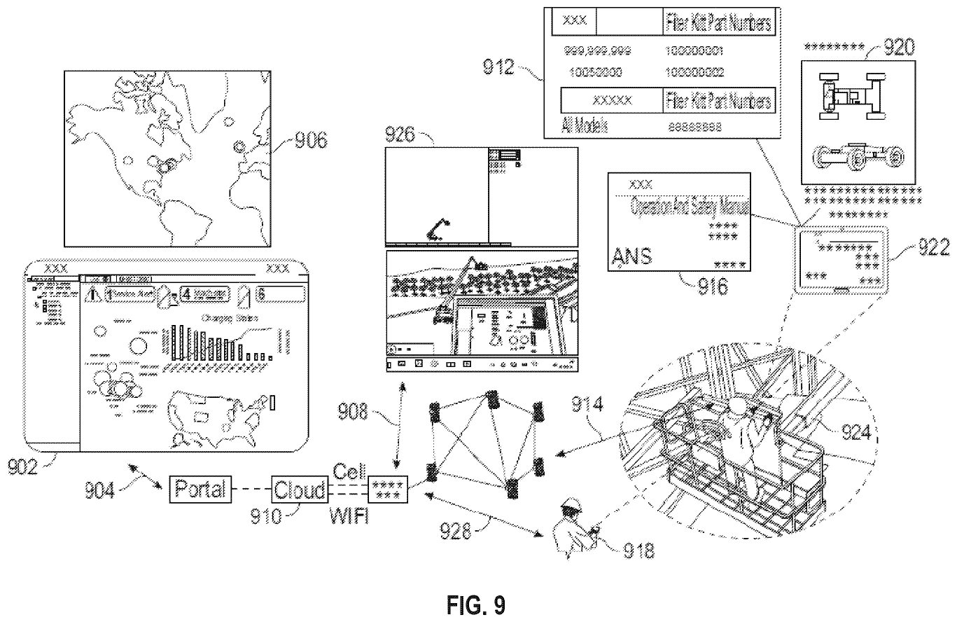

As shown in FIG. 9, an ecommerce-enabled local fleet connectivity system 900 monitors, collects, and/or receives information related to the operation of a work machine 924. As shown in FIG. 9, the information may include location information 902; fleet information 906; maintenance, spares, and repair information 912; operations and safety manuals 916 specific to the work machine 924; illustrated parts breakdowns 920; operation information 926; and/or other information stored on the work machine 924 or accessible and modifiable by users or other nodes via the ecommerce-enabled local fleet connectivity system.

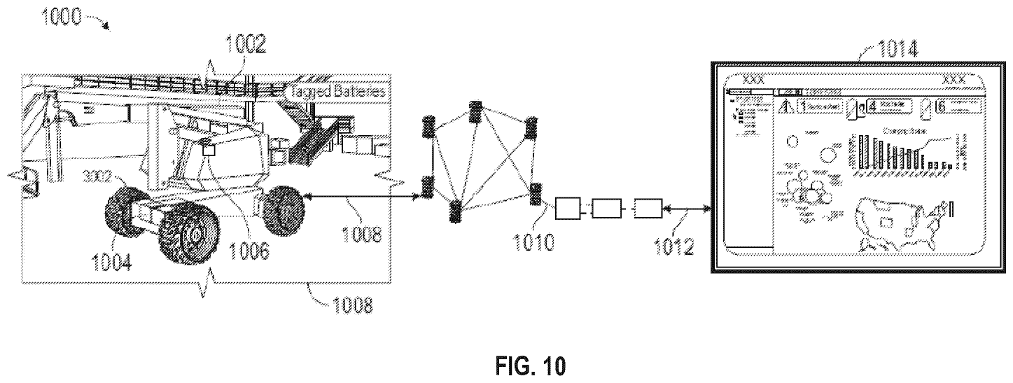

As shown in FIG. 10, an ecommerce-enabled local fleet connectivity system 1000 is shown to include information on tagged consumables. A work machine 1002 on a worksite 1008 includes tagged consumables 1004 (e.g., batteries connected to battery charger 1006). The machine 1002 sends and receives data 1016 to and from the connectivity hub 1010. The connectivity hub 1010 sends and receives data 1012 to and from a user interface 1014. Data regarding the tagged consumables 1004 may be stored locally on the work machine 1002 or communicated to the user interface 1014 via the connectivity hub 1010. For example, source information, maintenance records, battery charge state and battery health may be stored locally and sent to the user interface 1014. The information on the tagged consumables 1004 may be used by an ecommerce application of machine 1002 and/or connectivity hub 1010 to provide advertisements based on the work machine 1002 and worksite 1008 including additional parts, supplies, and services.

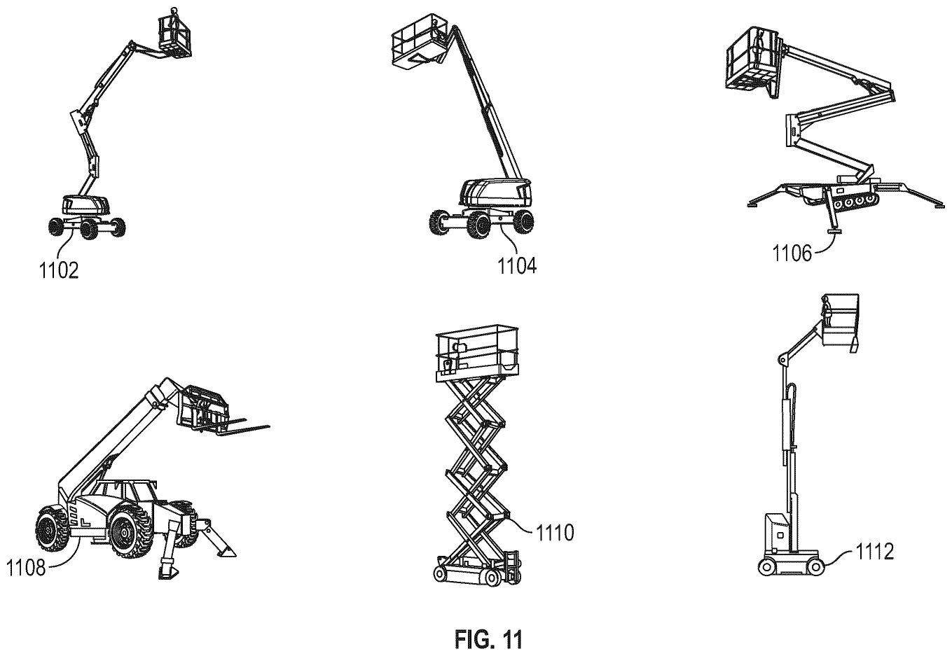

As shown in FIG. 11, the ecommerce-enabled local fleet connectivity system and methods described above may be implemented using various work machines 20 such as an articulating boom lift 1102 as shown in FIG. 11, a telescoping boom lift 1104 as shown in FIG. 11, a compact crawler boom lift 1106 as shown in FIG. 11, a telehandler 1108 as shown in FIG. 11, a scissor lift 1110, and/or a toucan mast boom lift 1112.

According to the exemplary embodiment shown in FIG. 11, the work machine 20 (e.g., a lift devices, articulating boom lift 1102, telescoping boom lift 1104, compact crawler boom lift 1106, telehandler 1108, toucan mast boom lift 1112) may include a chassis (e.g., a lift base), which supports a rotatable structure (e.g., a turntable, etc.) and a lifting device such as a boom assembly (e.g., boom). In other embodiments, the lifting device may be a scissor lift assembly, such as shown in scissor lift 1110. According to an exemplary embodiment, the turntable is rotatable relative to the lift base. According to an exemplary embodiment, the turntable includes a counterweight positioned at a rear of the turntable. In other embodiments, the counterweight is otherwise positioned and/or at least a portion of the weight thereof is otherwise distributed throughout the work machines 20 (e.g., on the lift base, on a portion of the boom, etc.). As shown in FIG. 11, a first end (e.g., front end) of the lift base is supported by a first plurality of tractive elements (e.g., wheels, etc.), and an opposing second end (e.g., rear end) of the lift base is supported by a second plurality of tractive elements (e.g., wheels). According to the exemplary embodiment shown in FIG. 11, the front tractive elements and the rear tractive elements include wheels; however, in other embodiments the tractive elements include a track element.

As shown in FIG. 11, the boom includes a first boom section (e.g., lower boom, etc.) and a second boom section (e.g., upper boom, etc.). In other embodiments, the boom includes a different number and/or arrangement of boom sections (e.g., one, three, etc.). According to an exemplary embodiment, the boom is an articulating boom assembly. In one embodiment, the upper boom is shorter in length than lower boom. In other embodiments, the upper boom is longer in length than the lower boom. According to another exemplary embodiment, the boom is a telescopic, articulating boom assembly. By way of example, the upper boom and/or the lower boom may include a plurality of telescoping boom sections that are configured to extend and retract along a longitudinal centerline thereof to selectively increase and decrease a length of the boom.

As shown in FIG. 11, the lower boom has a first end (e.g., base end, etc.) and an opposing second end (e.g., intermediate end). According to an exemplary embodiment, the base end of the lower boom is pivotally coupled (e.g., pinned, etc.) to the turntable at a joint (e.g., lower boom pivot, etc.). As shown in FIG. 11, the boom includes a first actuator (e.g., pneumatic cylinder, electric actuator, hydraulic cylinder, etc.), which has a first end coupled to the turntable and an opposing second end coupled to the lower boom. According to an exemplary embodiment, the first actuator is positioned to raise and lower the lower boom relative to the turntable about the lower boom pivot.

As shown in FIG. 11, the upper boom has a first end (e.g., intermediate end, etc.), and an opposing second end (e.g., implement end, etc.). According to an exemplary embodiment, the intermediate end of the upper boom is pivotally coupled (e.g., pinned, etc.) to the intermediate end of the lower boom at a joint (e.g., upper boom pivot, etc.). As shown in FIG. 11, the boom includes an implement (e.g., platform assembly) coupled to the implement end of the upper boom with an extension arm (e.g., jib arm, etc.). In some embodiments, the jib arm is configured to facilitate pivoting the platform assembly about a lateral axis (e.g., pivot the platform assembly up and down, etc.). In some embodiments, the jib arm is configured to facilitate pivoting the platform assembly about a vertical axis (e.g., pivot the platform assembly left and right, etc.). In some embodiments, the jib arm is configured to facilitate extending and retracting the platform assembly relative to the implement end of the upper boom. As shown in FIG. 11, the boom includes a second actuator (e.g., pneumatic cylinder, electric actuator, hydraulic cylinder, etc.). According to an exemplary embodiment, the second actuator is positioned to actuate (e.g., lift, rotate, elevate, etc.) the upper boom and the platform assembly relative to the lower boom about the upper boom pivot.

According to an exemplary embodiment, the platform assembly is a structure that is particularly configured to support one or more workers. In some embodiments, the platform assembly includes an accessory or tool configured for use by a worker. Such tools may include pneumatic tools (e.g., impact wrench, airbrush, nail gun, ratchet, etc.), plasma cutters, welders, spotlights, etc. In some embodiments, the platform assembly includes a control panel to control operation of the work machines 20 (e.g., the turntable, the boom, etc.) from the platform assembly. In other embodiments, the platform assembly includes or is replaced with an accessory and/or tool (e.g., forklift forks, etc.).

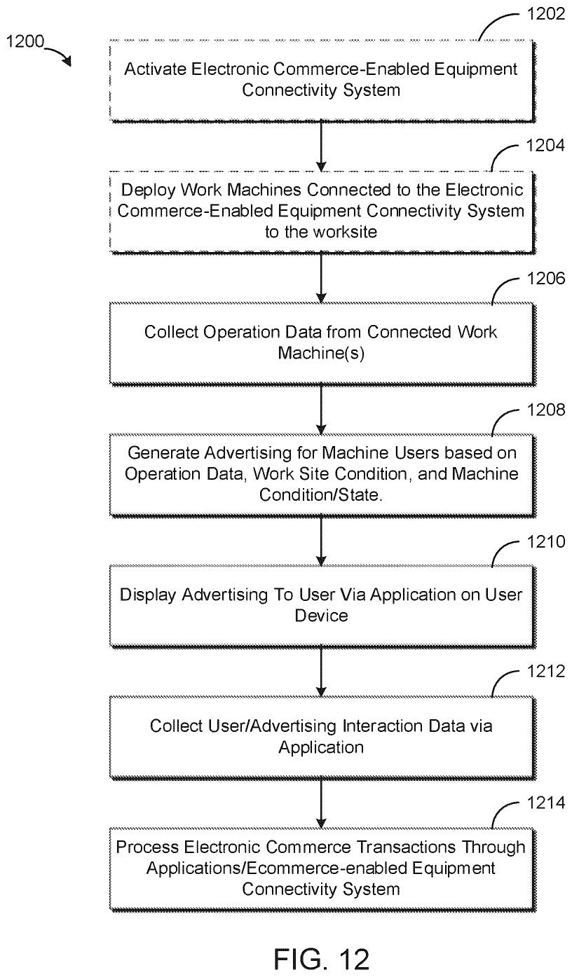

Referring to FIG. 12, a method 1200 for an electronic commerce-enabled local fleet connectivity system and/or application is shown, according to an exemplary embodiment. One or more steps in the method of FIG. 12 may be performed by the controller 44, the control system 60, the external input 72, the control module 206, the connectivity module 218, and or the user interface 272. In some embodiments, the method 1200 is performed by an ecommerce application. The ecommerce application may be run on a work machine or a user device. For example, a work machine comprising a connectivity module 218 may host the ecommerce application. At optional steps 1202 and 1204, an electronic commerce-enabled local fleet connectivity system is activated and work machines are deployed to a worksite. In some embodiments, the work machines each include a connectivity module configured to communicably connect the work machines to an ecommerce-enabled local fleet connectivity system. For the example, a controller of the work machines may include the connectivity module. In some embodiments, optional steps 1202 and 1204 are bypassed and the ecommerce system is implemented via an ecommerce application run locally on a work machine and/or a user device. At step 1206 operation data is collected from the connected work machines(s). A user may select a work machine via the ecommerce application on the user device. In some embodiments, the connected work machines are those connected to the local fleet connectivity system that the ecommerce application may run within. The operation data collected may include data from a specific machine or machines being accessed, a profile or nature of the user accessing the specific machine or machines, weather or local conditions around the machine or machines, conditions associated with the machine (e.g., engine hours, fault codes, etc.), location of the machine, etc. The operation data may include group data such as the number of machines on site, their average age, their typical runtimes, etc. The operation data may also include machine specific data such as manufacturer, operator, age, maintenance states, location, etc. The operation data may also include work site specific information, for example environmental conditions, operators, project stage, etc. The operation data may also include user specific information including a user type (e.g., owner, operator, etc.), user status, and other information regarding a user. In some embodiments, the operation information may be collected by a work machine or a user device connected to the ecommerce-enabled local fleet connectivity system. At step 1208, an ecommerce engine and associated electronic commerce applications receive operation data from machine(s) and user device(s). The ecommerce engine and applications generate and transmit electronic commerce messages (e.g. targeted advertising) based on the collected operation data. For example, based on data indicating a part requires replacement, the ecommerce application may generate an advertisement for a replacement product. For another example, based on data indicating that the machines on the worksite have ceased functioning at 11:45 AM, the ecommerce application may generate an advertisement for a third-party restaurant nearby the worksite. In some embodiments, generating the advertisement includes querying and receiving third-party information. For example, the ecommerce application may determine which of a group of third-party advertisements to select based on a user group size determined from the operation information. In another embodiment, the advertising may be based on work site condition. For example, the operation data may indicate that a worksite has endured substantial periods of rain, which the ecommerce application may associate with a need for greater service on machine tractive elements such as tires and tracks. The ecommerce application may generate an advertisement including information for a local servicer.

At step 1210, the generated advertisement, including for example products and services (e.g., OEM service kits) are presented to a user on a user device with, for example, a tab or page within an application, a click-through popup within the application, a scrolling banner within the application, push notifications, etc. In some embodiments, the advertisements are displayed to a user of the work machine directly on the work machine via an integrated display. In other embodiments, the advertisements are displayed to a user via a display on a user device (e.g., smartphone, tablet, laptop, etc.). For example, a site manager with a user device running an ecommerce enabled application for interfacing with a local fleet connectivity system may also display the advertising in the application.

At step 1212, the ecommerce application may also collect user/advertising interaction data via the application. For example, an owner of the work machines may collect user interaction data including statistics regarding the viewing, dismissing, or interaction with an advertisement. The owner may use the statistics to determine how effective the in-app advertising may be. For example, the owner may determine that predictive maintenance advertisements are more effective than predictive third-party advertisements.

At step 1214, the ecommerce application may, based on the user interaction, process an electronic transaction through the application. In some embodiments, the ecommerce application run in the ecommerce-enabled local fleet connectivity system may include a point of sale portal. The point of sale portal can allow a user interacting with an advertisement the purchase the recommended product or service directly through the app. In some embodiments, the ecommerce application may offer an associated discount for purchases made through the in-app portal.

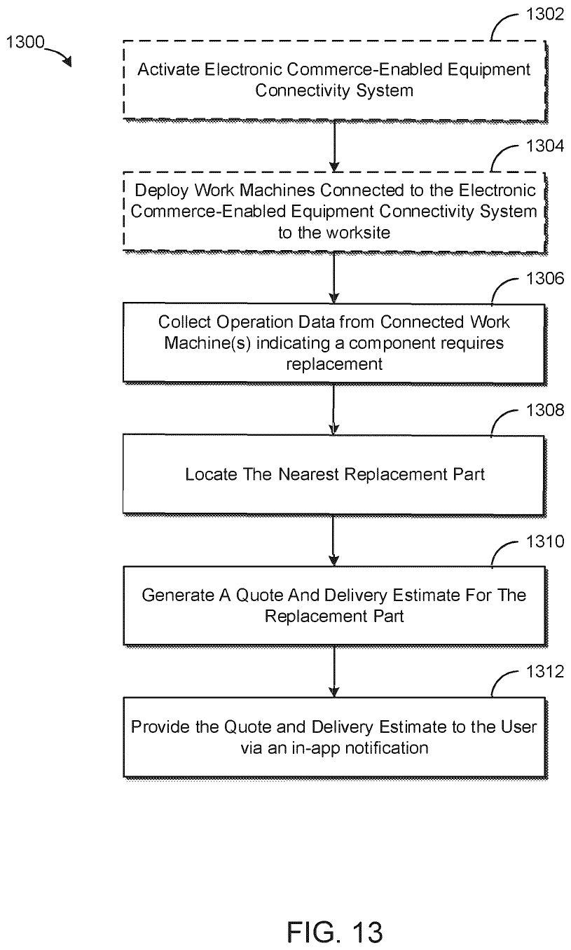

Referring now to FIG. 13, a method 1300 for providing a replacement product advertisement via a ecommerce application and/or enabled local fleet connectivity system is shown, according to an exemplary embodiment. At optional steps 1302 and 1304, an ecommerce-enabled local fleet connectivity system is activated and work machines connected to the system are deployed at a work site. As described above, in some embodiments the ecommerce-enabled local fleet connectivity system may be a local mesh network established by the work machines. In some embodiments, the ecommerce application in the ecommerce-enabled local fleet connectivity system is run on processors contained in the work machines. In some embodiments, the ecommerce application is run on processors contained in a remote device such as a user device connected to the ecommerce-enabled local fleet connectivity system. In some embodiments, method 1300 is performed on a work machine and/or user device not connected to a local fleet connectivity system. In some embodiments, the ecommerce application may perform one or more of the steps below entirely on a controller of a work machine or a user device comprising a processor, memory, and a user interface.

At step 1306 the ecommerce application collects operation data indicating a component requires replacement. In some embodiments, the operation data may include a component age, component time in use, a component fault indicator, a maintenance request, and other information that may be used to determine a component may require a replacement.

At step 1308 the ecommerce application may automatically locate the nearest replacement component. In some embodiments, the ecommerce application connects to a remote server to determine the location of the nearest component. In some embodiments, the location of the nearest component is offered by a third-party service. At step 1310, the ecommerce application may generate a quote and delivery estimate for the replacement part. The quote and delivery estimate may include price recommendation based on the location of the replacement part, the original component requiring replacement, user information, etc.

At step 1312, the ecommerce application may provide the quote and delivery estimated to the user via an in-app notification, for example, a tab or page within an application, a click-through popup within the application, a scrolling banner within the application, push notifications, etc. In some embodiments, the notification is integrated into the graphical user interface of the application. In some embodiments, the notification is accompanied with an alert such as a light, sound, or vibration. The notification may be provided to user via the local fleet connectivity system.

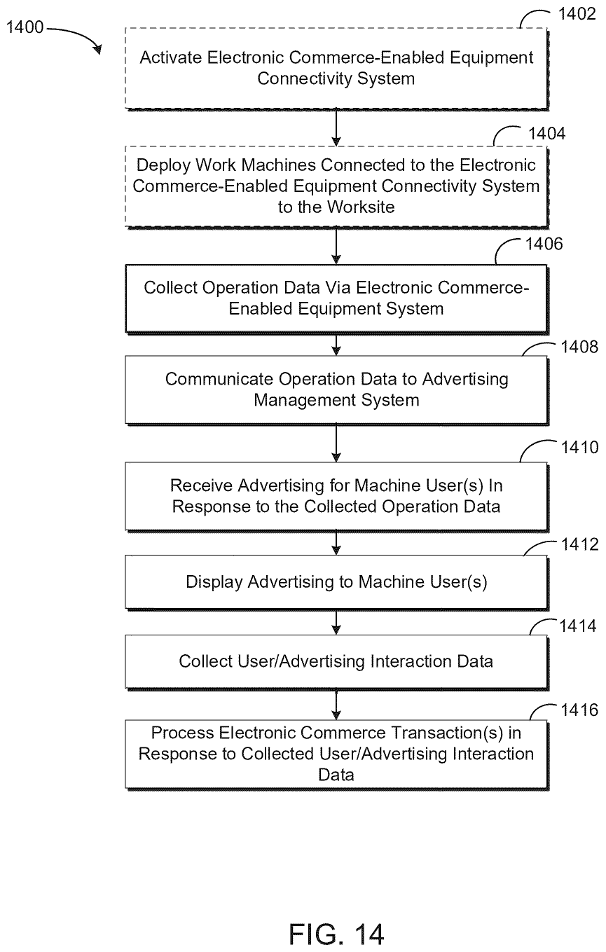

Referring to FIG. 14, a method 1400 for an electronic commerce-enabled local fleet connectivity system and/or application is shown, according to an exemplary embodiment. One or more steps in the method of FIG. 14 may be performed by the controller 44, the control system 60, the external input 72, the control module 206, the connectivity module 218, and or the user interface 272. In some embodiments, the method 1400 is performed by an ecommerce application. The ecommerce application may be run on one or more work machine(s) or one or more user device(s) (e.g., one or more mobile computing devices). For example, in one embodiment, a work machine comprising a connectivity module 218 may host the ecommerce application. As described above, in some embodiments the ecommerce-enabled local fleet connectivity system may be a local mesh network established by the work machines. In some embodiments, the ecommerce application in the ecommerce-enabled local fleet connectivity system is run on (e.g., method 1400 is performed by) processors contained in the work machines. In some embodiments, method 1400 is performed on processors contained in a remote device such as a user device connected to the ecommerce-enabled local fleet connectivity system. In some embodiments, method 1400 is performed on a work machine and/or user device not connected to a local fleet connectivity system. In some embodiments, the ecommerce application may perform one or more of the steps of method 1400 entirely on a controller of a work machine or a user device comprising a processor, memory, and a user interface.

At optional steps 1402 and 1404, an electronic commerce-enabled local fleet connectivity system is activated and work machines are deployed to a worksite. In some embodiments, the work machines each include a connectivity module configured to communicably connect the work machines to an ecommerce-enabled local fleet connectivity system. For the example, a controller of the work machines may include the connectivity module. In some embodiments, optional steps 1402 and 1404 are bypassed and the ecommerce system is implemented via an ecommerce application run locally on a work machine and/or a user device. In some embodiments, a user may select a work machine via the ecommerce application on a user device. In some embodiments, one or more connected work machines are those connected to the local fleet connectivity system that the ecommerce application may run within.

At step 1406 operation data is collected through the electronic commerce-enabled equipment system (e.g., from one or more connected user device(s) and/or one or more connected work machine(s)). The operation data collected may include data from a specific machine or machines being accessed, a profile or nature of the user accessing the specific machine or machines, weather or local conditions around one or more connected work machine(s), conditions associated with connected work machine(s) (e.g., engine hours, fault codes, battery level(s), engine temperature, etc.), the location of connected work machine(s), etc.

Additionally, in some embodiments, the operation data may include group data such as the number of work machine(s) on site, their average age, their typical runtimes, etc. The operation data may also include machine specific data such as manufacturer, operator, age, maintenance states, location, etc. Similarly, in some embodiments, operation data may also include worksite specific information, for example a total number of workers at a worksite, environmental conditions present at the worksite (e.g., wind speed, ambient temperature, humidity, precipitation, etc.), a number of machine operators present at the worksite, project stage, schedule information (e.g., planned breaks or meal times) for one or more user(s) or one or more connected work machine(s) located at the worksite), etc. In some embodiments, the operation data may also include user specific information including a user type (e.g., owner, operator, foreman, manager, etc.), user status (e.g., operating a connected work machine), and other information regarding one or more user(s). In some embodiments, the operation information may be collected from (e.g., transmitted by) one or more connected work machine(s) or one or more user device(s) that are connected to the ecommerce-enabled local fleet connectivity system. In some embodiments, the operation data may include a component age, component time in use, a component fault indicator, a maintenance request, and other information that may be used to determine a component may require a replacement.

At step 1408 the ecommerce application may automatically locate the nearest replacement component. In some embodiments, the ecommerce application connects to a remote server to determine the location of the nearest component. In some embodiments, the location of the nearest component is offered by a third-party service. At step 1310, the ecommerce application may generate a quote and delivery estimate for the replacement part. The quote and delivery estimate may include price recommendation based on the location of the replacement part, the original component requiring replacement, user information, etc.

At step 1412, the ecommerce application may provide the quote and delivery estimated to the user via an in-app notification, for example, a tab or page within an application, a click-through popup within the application, a scrolling banner within the application, push notifications, etc. In some embodiments, the notification is integrated into the graphical user interface of the application. In some embodiments, the notification is accompanied with an alert such as a light, sound, or vibration. The notification may be provided to user via the local fleet connectivity system.

Although the systems and methods are described herein with reference to a lift device, a lift assembly, or a work machine, the systems and methods may additionally or alternatively be applied to any other type of vehicle or machine. By way of example, these systems and methods may apply to any type of lift device (e.g., boom lifts, scissor lifts, vertical lifts, manual lifts, aerial work platforms, telehandlers, etc.). By way of another example, these systems and methods may apply to vocational vehicles, such as fire fighting vehicles, fire trucks, concrete mixers, delivery vehicles, military vehicles, refuse vehicles, etc.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

While various circuits with particular functionality are shown in FIGS. 1-3, it should be understood that the controller 44 may include any number of circuits for completing the functions described herein. For example, the activities and functionalities of the control system 60 may be combined in multiple circuits or as a single circuit. Additional circuits with additional functionality may also be included. Further, the controller 44 may further control other activity beyond the scope of the present disclosure.

As mentioned above and in one configuration, the “circuits” of the control system 60 may be implemented in machine-readable medium for execution by various types of processors, such as the processor 52 of FIG. 1. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the load map interface systems and methods as shown in the various exemplary embodiments is illustrative only. Additionally, any element disclosed in one embodiment may be incorporated or utilized with any other embodiment disclosed herein. For example, the warning zones of the exemplary embodiment may be eliminated or additional zones may be added. Although only one example of an element from one embodiment that can be incorporated or utilized in another embodiment has been described above, it should be appreciated that other elements of the various embodiments may be incorporated or utilized with any of the other embodiments disclosed herein.

Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. An electronic commerce system, comprising:
one or more work machines proximate to a jobsite;
one or more user devices associated with the jobsite;
a controller communicably coupled to the one or more work machines and communicably coupled to the one or more user devices, the controller configured to:
collect, via a wireless network, operation data from each of the one or more work machines and the one or more user devices;
generate jobsite data based on the operation data;
communicate, via a communications network, the jobsite data to a remote server;
receive, via the communications network, a recommendation based on the jobsite data; and
display the recommendation to one or more users via a graphical user interface of at least one or more work machines or one or more user devices.

2. The electronic commerce system of claim 1, further comprising a second work machine connected to the work machine via a wireless network, wherein the wireless network is a local mesh network hosted by the work machine and the second work machine.

3. The electronic commerce system of claim 2, wherein the local mesh network is a Bluetooth Low Energy (BLE) mesh network.

4. The electronic commerce system of claim 1, the work machine further comprising a sensor configured to obtain operation data related to the work machine.

5. The electronic commerce system of claim 1, wherein the operation data comprises at least one of a work machine state, a work machine load, a user profile, worksite environmental conditions, the time of day, or the location of the work machine.

6. The electronic commerce system of claim 1, wherein the recommendation comprises a recommended purchase for the user.

7. The electronic commerce system of claim 1, wherein the recommendation comprises original equipment manufacturer advertising.

8. The electronic commerce system of claim 1, wherein the operation data includes a location of the work machine, and an indication that a first component of the work machine requires replacement, the controller further configured to:
locate a nearest replacement component via a query to a remote server connected to the controller via the wireless network;
generate a quote and an estimated delivery time using the location of the work machine; and
provide, via the graphical user interface, the recommendation, wherein the recommendation includes the location of the nearest replacement component, the quote, and the estimated delivery time to the user via the graphical user interface.

9. The electronic commerce system of claim 1, wherein the recommendation comprises an advertisement from a third-party based on the operation data.

10. The electronic commerce system of claim 1, wherein the operation data comprises a user profile, the controller further configured to:
retrieve the user's billing information based on the user profile; and
initiate the transaction implementing the recommendation according to the user's billing information.

11. The electronic commerce system of claim 1, wherein the controller is further configured to:
collect operation data from at least one of the work machine or the user device;
determine, from the operation data, that the work machine requires servicing; and
generate the recommendation, wherein the recommendation comprises a suggested service location and a suggested service time.

12. The electronic commerce system of claim 1, wherein the user device is wirelessly connected to the work machine, and the user device comprises the controller and the display.

13. The electronic commerce system of claim 1, wherein the controller is integrally coupled to the work machine.

14. A method of providing work machine-related advertising, the method comprising;
providing a first work machine;
providing a user device connected to the first work machine via a wireless network;
generating, with a controller, a graphical user interface on a display, the graphical user interface comprising information related to the first work machine;
collecting operation data from at least one of the first work machine and the user device;
generating a recommendation for the user based on the operation data;
providing the recommendation to the user via the graphical user interface;
receiving a user input interacting with the recommendation; and
initiating a transaction implementing the recommendation.

15. The method of claim 14, wherein the wireless network is a local Bluetooth Low Energy (BLE) mesh network.

16. The method of claim 14, wherein the first work machine comprises a sensor configured to obtain operation data related to the first work machine.

17. The method of claim 14, wherein the operation data comprises at least one of a work machine state, a work machine load, a user profile, worksite environmental conditions, the time of day, or the location of the work machine.

18. The method of claim 14, further comprising:
a second work machine connected to the first work machine via a local wireless network, wherein the local wireless network is a mesh network established by the first work machine and the second work machine.

19. The method of claim 14, wherein the operation data includes a location of the first work machine, and an indication that a first component of the first work machine requires replacement, the method further comprising the steps of:
locating a replacement component via a query to a remote server connected to the controller via the wireless network;
generating a quote and an estimated delivery time using the location of the work machine and the location of the replacement component; and
providing, via the graphical user interface, the recommendation, wherein the recommendation includes the location of the nearest replacement component, the quote, and the estimated delivery time to the user via the graphical user interface.

20. A work machine comprising;
a chassis;
an implement coupled to the chassis;
a prime mover configured to power the implement;
a sensor coupled to the chassis and position to monitor the operation of the work machine; and
a non-transitory computer-readable storage medium having instructions stored thereon that, upon execution by a processor of a controller cause the processor to:
generate a graphical user interface on a display, the graphical user interface comprising information related to the work machine;
collect operation data from at least one of the work machine or a user device communicably coupled to the work machine;
generate a recommendation based on the operation data;
provide the recommendation to a user via the graphical user interface;
receive a user input interacting with the recommendation; and
initiate a transaction implementing the recommendation.
